(19) United States
(12) Patent Application Publication
(10) Pub. No.: US 2004/0129386 A1
(43) Pub. Date: Jul. 8, 2004

(54) Apparatus for dispensing adhesive tape

(75) Inventor: Alfred Langerak, Mijnsheerenland (NL)

Correspondence Address: BANNER & WITCOFF, LTD., 28 STATE STREET, 28th FLOOR, BOSTON, MA, 02109-9601, US

(73) Assignee: InnoSeal Systems International B.V.i.o., Capelle a/d IJssel (NL)

(21) Appl. No.: 10/693,641

(22) Filed: Oct. 24, 2003

Related U.S. Application Data
(63) Continuation of application No. PCT/NL02/00267, filed on Apr. 24, 2002.

(30) Foreign Application Priority Data
Apr. 24, 2001 (NL) 1017933

(51) Int. Cl. B32B 31/00; C09J 1/00

(52) U.S. Cl. 156/522; 156/579

(57) ABSTRACT

An apparatus for dispensing adhesive tape, provided with a housing and receiving a supply roll of adhesive tape and guiding means for, during use, feeding to and through the dispense opening a leading end of adhesive tape unwound from the supply roll brought outside the dispense opening, wherein operating means are provided for moving the cutting means between a first position largely retracted in the housing and a second, cutting position, wherein the cutting means can be brought into contact with adhesive tape fed into and/or through the dispense opening.

A known apparatus for dispensing adhesive tape is a box closer. This apparatus comprises a frame having a stub thereon, on which a roll of adhesive tape can be slipped. On the same frame, on the side facing the box during use, a pressure roller is provided along which tape is guided, while a spring holds the tape against the pressure roller. Above the pressure roller, a knife is provided with a serrated cutting edge. The frame is carried by a handle. During use, a roll of adhesive tape is secured on the stub, such, that the adhesive tape is guided along the pressure roller with the adhesive side facing away from the pressure roller and the knife. The adhesive tape is pressed by the free end against a box, whereupon the apparatus is moved away from the free end. By the adhesive force of the adhesive tape, the roll is unwound, while the unwound portion of the adhesive tape can be pressed against the box with a lip arranged adjacent the pressure roller. When sufficient adhesive tape has been unwound, it is tautened and the apparatus is pivoted such, that the adhesive tape is cut off by the knife and the free end is held against the knife. Upon further use, each time, a new portion of adhesive tape is ready for adhesion to a new box.

This known apparatus has as an advantage that in a simple manner and with few operations, adhesive tape can be applied. However, an important disadvantage is that the knife is always accessible. This presents danger to users and to the surroundings, while, moreover, damage can easily occur to the surface to which the adhesive tape is to be or has been provided. The fact is that the knife can accidentally come into contact with that surface. Also when the apparatus is not in use, this knife presents danger.

The invention contemplates an apparatus for dispensing adhesive tape, wherein the drawbacks of the known apparatus mentioned in the opening paragraph are obviated, while maintaining its advantages. To that end, an apparatus according to the invention is characterized by the features of claim 1.

An apparatus according to the invention is provided with a housing in which, during use, the cutting means are at least substantially received, such that the cutting means are screened off towards the surroundings, at least when they are not used. Operating means are then provided for actively moving the cutting means between a retracted position and a position of use, while the cutting means can only cut off or tear off the adhesive tape in or near the position of use. Thus, a safe apparatus is provided for dispensing adhesive tape, which, moreover, is simple in use. Damage and injuries are easily prevented, while, moreover, in a particularly simple and efficient manner the cutting means are protected, in particular also when the apparatus is not used.

Herein, the term housing is understood to mean that at least the cutting means are screened off from the surroundings by it, at least in a retracted position and preferably also substantially during cutting the tape. Moreover, it is preferred that the cutting means are retracted within the housing when new tape has to be inserted. The tape itself can but need not be received within the housing.

In an advantageous embodiment, an apparatus according to the invention is further characterized by the features of claim 4.

In such an embodiment, with the aid of the blocking means, a safe position of the cutting means is provided for when the housing is opened, at least when new tape is inserted. Preferably, these blocking means are operated by a flap of the housing. It is particularly advantageous when the operating means for the cutting means are blocked upon opening of the flap, while the blocking means are arranged for preventing the flap from opening before the cutting means are brought into the first position.

In a further embodiment, an apparatus according to the invention is further characterized by the features of claim 8.

With such an apparatus, in a particularly simple manner, adhesive tape can be moved in the direction of and through the dispense opening for engagement by, for instance, a product or a person.

An apparatus according to the invention can particularly advantageously be used for dispensing tape for medical applications, in particular for or near the skin. In particular in such an application, it is of particular importance that the cutting means cannot come into contact with the hands or other body parts of a user or a patient. In such an embodiment, it is further preferred that the apparatus is autoclavable or differently sterilizable, preferably in its entirety. Thus, hygiene is guaranteed.

In a further embodiment, an apparatus according to the invention can particularly suitably be designed for dispensing adhesive tape for closing boxes and the like, characterized by the features of claim 14.

In such an embodiment, a relatively compact construction can be obtained wherein the supply roll for adhesive tape and the guiding means can be substantially included in the housing, together with the cutting means, while a handle is provided with which the apparatus can be operated in a simple manner.

The receiving means for the supply roll are preferably fastened on a base plate, which is movable relative to the housing, while a pressure roller is connected to the base plate for pressing on adhesive tape extending along the pressure roller mentioned. Then, the pressure roller is arranged for pressing the adhesive tape through the dispense opening. Thus, in a particularly simple manner, it is provided that adhesive tape is always accessible from outside the housing. Preferably, movement of the base plate and cutting means are coupled such, that when the pressure roller is moved to or into the dispense opening, the cutting means are retracted, vice versa.

In a particularly advantageous embodiment, an apparatus according to the invention is farther characterized by the features of claim 17.

In such an embodiment, it is provided that a supply roll of adhesive ape can be inserted in or on the receiving means in only one position so that, each time, it is ensured that the adhesive tape is inserted with the adhesive side in the right direction. Moreover, thus, it can be provided that always the right roll of adhesive tape is inserted.

In the subclaims, further advantageous embodiments are represented of an apparatus according to the present invention.

In clarification of the invention, exemplary embodiments of an apparatus according to the invention will be further elucidated with reference to the drawing. In the drawing:

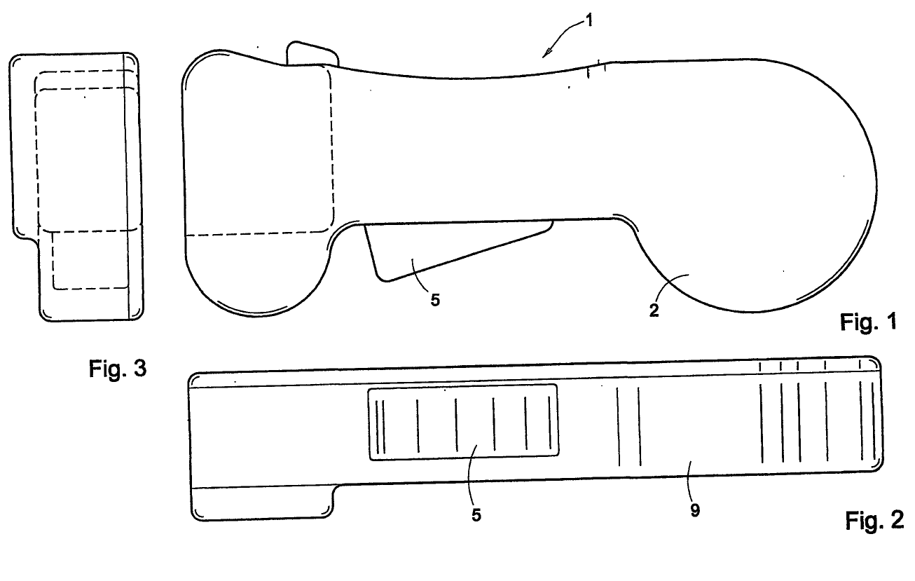

FIGS. 1-3 show, in side, bottom and front view, an apparatus according to the invention in a first embodiment;

FIG. 4 shows in cutaway side view, schematically, a rear end of an apparatus according to FIG. 1;

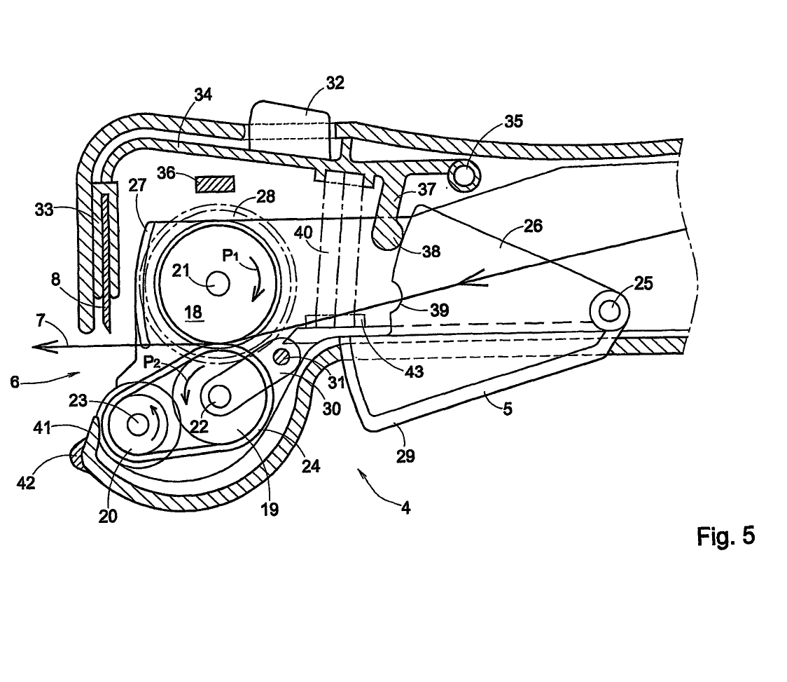

FIG. 5 shows, in cutaway side view, schematically, a front end of an apparatus according to the FIG. 1;

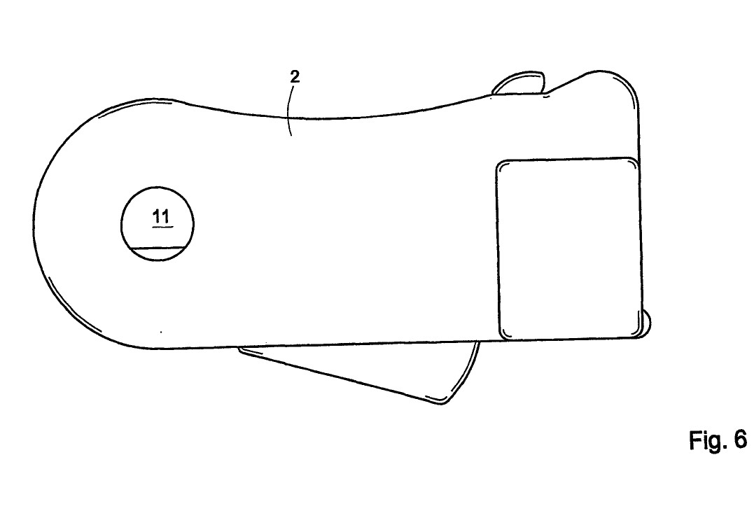

FIG. 6 shows, in side view, a first alternative embodiment of an apparatus according to the invention;

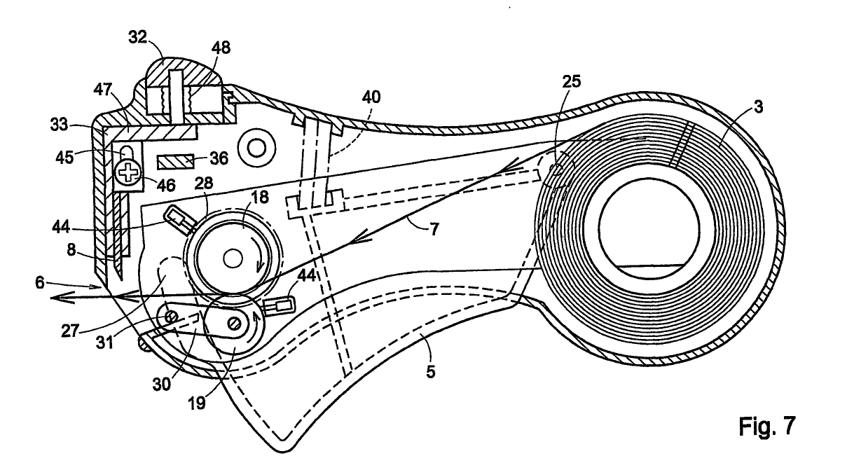

FIG. 7 shows, in cutaway side view, an apparatus according to FIG. 6;

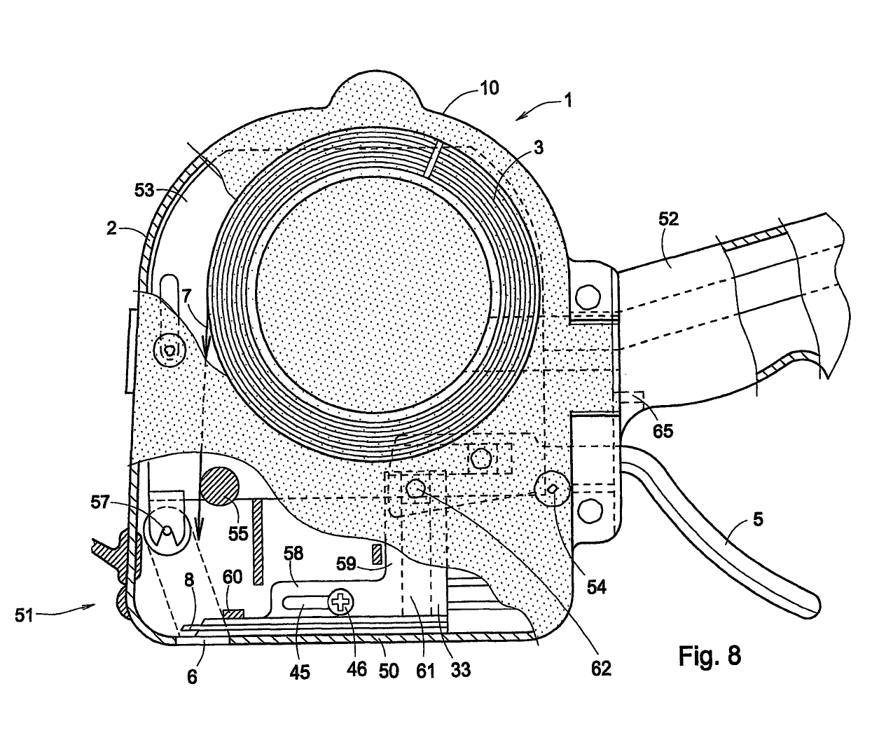

FIG. 8 shows, in partly cutaway side view, a dispensing apparatus according to the invention in a third embodiment, in particular suitable for use for closing boxes;

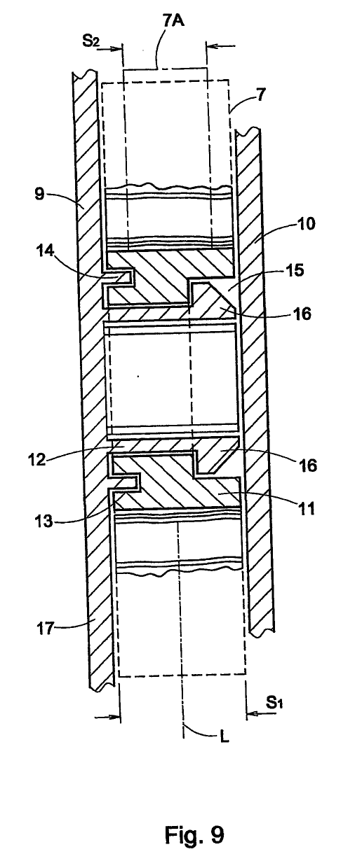

FIG. 9 shows, in partly cutaway view, a roll of adhesive tape in an apparatus according to the invention; and

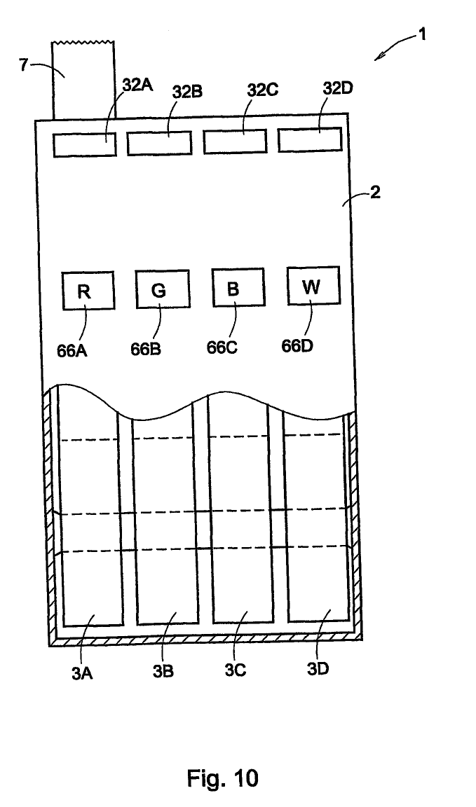

FIG. 10 shows, in partly cutaway top plan view, a further alternative embodiment of an apparatus according to the invention.

In this description, identical or corresponding parts have identical or corresponding reference numerals.

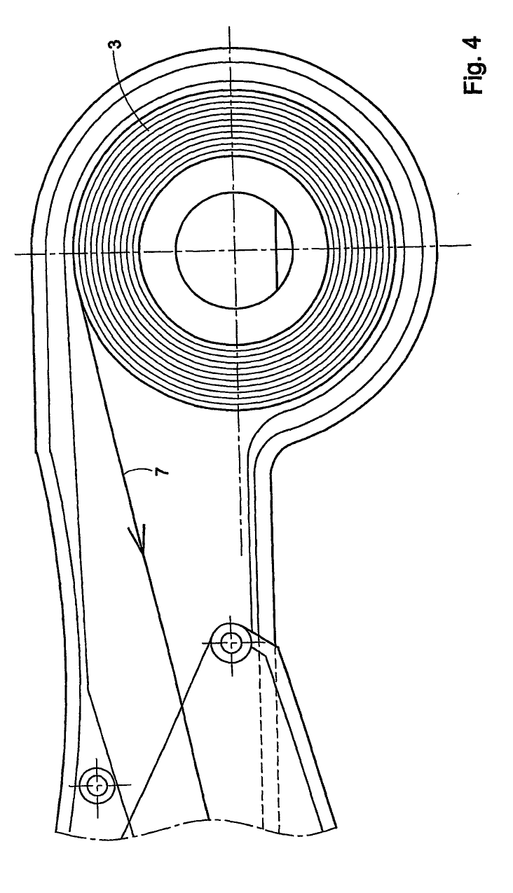

FIG. 1 shows, in side view, an apparatus for dispensing adhesive tape, further to be called a tape dispenser 1. FIGS. 2 and 3 show a bottom view and a front view, respectively, of this tape dispenser. In FIGS. 4 and 5, in cutaway side view, enlarged, a tape dispenser 1 according to FIGS. 1-3 is represented. The tape dispenser 1 comprises a housing 2 in which a roll of tape 3, for instance medical tape, is received, and a dispensing apparatus 4, which is operable with a handle 5, in a manner to be described hereinafter. In the housing 2, at a front side, a dispense opening 6 is provided, through which adhesive tape (tape) 7 can be dispensed from the roll 3. Within the housing 2, a cutting means in the form of a knife 8 is included which can be operated with the aid of a control button 32 between a first position, as shown in FIG. 5, where the knife 8 is moved upwards within the housing away from the opening 6, and a second, cutting position where the knife is moved downwards behind the opening, through tape 7 extending through the opening 6. Thus, the tape 7 can be cut off in a safe manner. The knife 8 does not reach outside the housing 2 and is consequently screened off from the surroundings, in particular from fingers and the like of a user, and from the surface on which the tape 7 is to be applied, for instance a human body.

The housing 2 is, for instance, manufactured from plastic or metal, such as aluminum or stainless steel, and comprises a shell part 9 and a cover 10 which can be closed, for instance hinged, thereagainst. In FIG. 9, in cross section, a rear part of the housing 2 is shown, with the roll 3 therein. The roll 3 is provided with a core 11 with which the roll can be pushed over fingers 12 such, that the core 11 is retained within the housing 2. The core 11 is of substantially cylindrical design and is provided at a first side with a circumferential groove 13 by which it can fall over an upright edge 14 in the shell part 9, which edge extends circularly around the fingers 12. At the opposite side, the core 11 is provided with a cylindrical recess 15 in which the heads 16 of the clamping fingers 12 can reach for securing the core 11 and hence the roll 3. The core 11 has a width such, that it can be fittingly received between the bottom 17 of the shell part 9 and the cover in closed position. As the core 11 is asymmetrical relative to a central longitudinal plane L, the roll can only be slipped on the fingers 12 in one manner, so that it is ensured that the adhesive side is always located at the correct side of the dispensed tape 7.

In FIG. 9, in interrupted lines, tape 7 is represented on the roll 3, which has a width S₁ which approximately corresponds to the distance between the bottom 17 and the cover 10, while in chain-dotted lines in FIG. 9 at the top a second width of tape 7A is represented, which has a width S₂. Thus, it is indicated that cores 11 with different widths of tape 7 can be wound, to be dispensed with the dispensing apparatus 4. It will be clear, for that matter, that also cores of a smaller width than the width S₁ can be used, as long as they can be confined with the aid of the fingers 12. Also, other fastening means can be used.

The dispensing apparatus 4 comprises a first, driven wheel 18, a second driven wheel 19 and a roller 20. The driven wheels 18, 19 and the roller 20 are mounted on axles 21, 22, 23, which axles extend approximately parallel to each other, at right angles to the bottom 17 of the shell part 9 and at right angles to the longitudinal direction of the tape 7. The second driven wheel 19 and the roller 20 are mutually connected by a belt 24 wrapped therearound, having a width approximately corresponding to that of the tape to be dispensed, for instance a width S₂. In the external surface, the belt 24 can be provided with longitudinal or cross grooves, so that its adhesive surface is reduced. The handle 5 is bearing-mounted on a pivot 25, which extends approximately parallel to the axle 21, and comprises a plate part 26 which, at the side of the first driven wheel 18 remote from the pivot 25, is provided with a curved toothed ring 27 with a bending radius which is equal to the distance from the pivot 25 to the toothed ring 27 mentioned. The toothed ring 27 is positioned such that it can move along the tape 7. The toothed ring 27 meshes with a gear wheel 28 which is fixedly connected to a side of the driven wheel 18. A part 29 of the handle 5 reaches outside the housing 2 such, that this can be engaged. If the handle 5 is moved from the position shown in FIG. 5, where the grip part 29 reaches outside the housing, in the direction of the housing, such that the grip part 29 mentioned is forced into the housing, then the plate part 26 and hence the toothed ring 27 will move upwards in FIG. 5, so that the driven wheel 18 will rotate about the axle 21, clock-wise in FIG. 5, as indicated by the arrow P₁. The second driven roller 19 is bearing-mounted with the axle 22 in a pivot plate 30, which can rotate about an axle 31 fixedly connected to the housing. With the aid of a torsion spring (not shown) the pivot plate 30 is forced in the direction of the first driven wheel 18, so that the second driven wheel 19 is pushed with the running surface of the belt 24 against the outer surface of the first driven wheel 18. This means that upon rotation of the first driven wheel 18 in the direction of the arrow P₁, the second driven wheel 19 will rotate in opposite direction, as indicated by the arrow P₂. Tape 7, confined between the first driven roller 18 and the belt 24 will thus be forced in and through the dispensing opening 6, so that it can be engaged from the outside of the housing. When the control button 32 is pressed in, the knife 8 is pushed through the tape 7, thereby cutting off the tape 7. Preferably, the tape 7 is then tautened by pulling the apparatus away, slightly backwards. The remaining part of the tape 7, between the knife and the driven rollers 18, 19, can then rest on the surface of the belt 24, so that this, upon renewed use, can be dispensed through the dispense opening 6 in a simple manner.

Tape 7 can be introduced in a simple manner by opening the cover, whereupon the second driven wheel 19, with the aid of the pivot plate 30, is pushed away from the first driven roller 18 and tape 7 can be inserted between the first driven roller 18 and the belt 24, whereupon the pivot plate 30 is released and the tape 7 is clamped between the rollers 18, 19. In the first driven roller 18, a ratchet mechanism is included, so that rotation of the first driven roller 18 in opposite direction, i.e. counter-clockwise in FIG. 5, is prevented. Thus it is provided that, when the handle 5 moves back from a pushed-in position to the position shown in FIG. 5, the driven rollers 18, 19 are prevented from rotating in the wrong direction. It will be clear that this can also be realized in a different manner, for instance by suitable blocking projections, by specifically selected toothing or by ensuring that, at the returning movement, the toothed ring 27 is brought out of mesh with the gear wheel 28.

In the embodiment shown, the movement of the knife 8 is at least substantially rectilinear, approximately parallel to the plane of the opening 6. Thus, an advantageous cutting direction is obtained with particularly simple means. To that end, the knife 8 is included in a holder 33, guided within the housing 2, for instance with the aid of suitably arranged guiding pins and grooves (not shown). Advantageously, the knife can then end in a point or have an inclining cutting edge. As a result, it will more easily cut through the tape. The holder 33 is carried on a pivot arm 34, which pivot arm is supported, at a distance from the dispense opening 6, by a pivot 35. A stop 36 is provided for limiting the stroke of the knife 8, in that the pivot arm 34 will move against the stop 36. Between the pivot 35 and the control button 32, at the side of the pivot arm 34 remote from the control button 32, a projection 37 is provided, provided at the bottom side with a protuberance 38. In the plate part 26 of the handle 5, a recess 39 is provided in which a part of the protuberance 38 can be received when the handle 5 is moved approximately entirely within the housing 2. Only then, the control button 32 can be pushed in and the knife 8 can be moved through the tape 7. What is thus prevented is that the knife 8 is operated without the handle 5 being entirely moved inwards. Thus, accidental operation of the knife 8 is prevented in an even simpler manner. A spring 40 is provided against the pivot arm 34 and is set against the housing 2, such that the pivot arm 34, in the first position shown in FIG. 5, is biased, so that the knife 8, each time upon release of the control button 32 is moved back to the first position.

At the bottom side of the dispense opening 6, the housing 12 is slightly bent off inwards, such that the lower longitudinal edge 41 of the dispense opening 6 is at a short distance from the belt 24, so that tape is prevented from being moved back within the housing with the aid of the belt 24. Under the lower longitudinal edge 41, at the outside of the housing 2, a soft nose part 42 is provided, so that damage to or injury of the surface onto which tape is applied is prevented in an even better manner.

It is preferred that the cover 10 can only be opened for replacing the roll 3, when the handle 5 is fixed in the position shown in FIG. 5, for instance in that, upon closure of the cover 10, a blocking projection 43 in front of the handle 5 is pushed away, which blocking projection 43, with the cover 10 opened, fixes the handle 5. Then, the knife 8 is prevented from being moved upon replacement of the roll 3, at least insertion of the tape 7 between the rollers 18, 19.

When an apparatus 1 according to the invention is used in, for instance, the medical field or the food industry, it is preferred that all parts thereof are manufactured from sterilizable, for instance autoclavable, material. In particular suitable to that end is, for instance, stainless steel.

In FIGS. 6 and 7, an alternative embodiment of an apparatus 1 according to the invention is shown, wherein, again, a housing 2 is provided within which a roll 3 of tape 7 can be confined. In this embodiment, the belt 24 with the roller 20 as shown in FIG. 5 is omitted. Here, the second driven wheel 19 is carried on a pivot plate 30 which is bearing-mounted on a pivot 31 which is provided adjacent the opening 6. Here, the handle 5 is pivotably bearing-mounted on a pivot 25, which is located relatively high in the housing 2, adjacent the core 11 of the roll 3. At the side of the first driving roller 18 remote from the pivot 25, the handle 5 is again provided with a gear rack or toothed ring 27, which meshes with a gear wheel 28, fixedly connected to the first driven wheel 18. Blockings 44 are provided against the first and second driven wheel 18, 19 for forming a ratchet mechanism, so that the driven wheels 18, 19 can only rotate in one direction, such that, therewith, tape 7 can be guided from the roll 3 through the dispense opening 6. Then, the first driven wheel 18 rotates clockwise, in FIG. 7, the second driven wheel 19 in opposite direction.

In this embodiment, the knife 8 is confined in an angular holder 33, in which a slot 45 is provided, through which a screw 46 is secured in the housing 2, as linear guide. On the leg 47, extending at right angles to the direction of movement of the knife 8, the control button 32 is provided, while a spring 48 is disposed between the control button 32 and the housing 2 for biasing the knife 8 in the first position shown in FIG. 7. Again, a blocking 36 limits the stroke of the knife 8, such that the knife substantially cannot reach through the dispense opening 6. A spring 40 is disposed between the handle 5 and the housing 2, so that the handle 5 is biased by the spring 40 in the position reaching outside the housing 2 shown in FIG. 7.

In FIG. 8, a further alternative embodiment of a tape dispenser 1 according to the invention is shown, which is particularly suitable for dispensing adhesive tape suitable for closing boxes or the like. Specifically, such an apparatus is particularly suitable for relatively wide tape.

In this embodiment, the apparatus 1 comprises a housing 2 with a somewhat rectangular side view with a flat bottom 50. In the bottom 50, a dispense opening 6 is provided, adjacent a front side 51. At the rear side of the housing 2, a grip 52 is provided with which the apparatus 1 can be held and operated. A handle 5 is provided underneath the grip 52 for operating the apparatus, as will be described hereinafter.

Within the housing 2, a base plate 53 is disposed, pivotable about a pivot 54. The pivot 54 is at a relatively large distance from the opening 6. The handle 5 is bearing-mounted in the same pivot 54. On the base plate 53, on a roll 3, tape 7 is disposed, for instance in a manner shown in FIG. 8. The tape 7 is guided from the roll 3 along a roller 55 arranged adjacent a bottom longitudinal edge of the base plate 53 and then through the dispense opening 6. Under the lower longitudinal edge of the base plate 53, a pressure roller 57 is provided, which, upon pivoting of the base plate 53 about the axle 54, can be moved in the direction of, and preferably into, the dispense opening 6, for moving the tape 7 therein.

Within the housing, against the bottom 50 a substantially L-shaped holder 33 is disposed, which, with a first leg 58, abuts against the bottom 50 and, with a second leg 59, extends approximately at right angles thereto. In the first leg 58, at the side facing the front side 51, a knife 8 is secured which is movable along the bottom and along the opening 6. In the first position shown in FIG. 8, the cutting side of the knife 8 is at the side of the opening 6 proximal to the front side 51. In the first leg 58, a slot 45 is provided in which a bolt 46 extends, which is secured in the housing. Thus, a linear guiding of the knife 8 is obtained. Moreover, a guiding projection 60 can rest against the upper side of the first leg 58, for an even better confinement. In the second leg 59, a second guiding slot 61 is provided, into which a pin 62 reaches which is fastened to an extremity of the handle 5, at a distance from the pivot 54. If the handle 5 is pulled against the grip 52, the pin 62 is moved downwards through the slot 61, which, as a result of the circular movement of the pin 62 around the pivot 54, will simultaneously pull the knife backwards, in the direction away from the front side 51, away from the opening 6. Simultaneously, the roll 3 is moved downwards, so that the pressure roller 57 will guide the tape through the dispense opening, so that this can be engaged outside the housing 2 and can be stuck to, for instance, a box or other object. By subsequently pulling away the apparatus 1 in the direction away from the front side 51, the tape can be dispensed from the roll 3, for instance for gluing up a box. If the handle 5 is moved back from this position to the position shown in FIG. 8, the base plate 53 is again moved back to the initial position and simultaneously the knife 8 is pushed in the direction of the front side 51, through the tape 7 extending through the opening 6, so that this is cut off. Then, it is preferred that spring means be provided for biasing the base plate 53 in the position shown in FIG. 8, for instance by providing a spring between the projection 60 and the knife holder 33 or by disposing a spring between the handle 5 and the housing 2.

In this embodiment, in the grip 52, a blocking projection 65 is provided which can be operated by a cover 10. Only when the handle 5 is pulled against the grip 52, thus pushing away the projection 65, the cover 10 can be opened. Then, the grip 5 is held by the projection 65 in the position pulled against the grip 52, so that the knife 8 is confined in the retracted position. Then, in a simple manner, the roll 3 can be replaced without the risk of the user hurting himself with the knife 8, in particular also as the knife 8 is then confined between the bottom 50 and the projection 60. If the cover 10 is closed again, the projection 65 is pushed away and the operating handle 5 is released so that the apparatus can be used again in a previously described manner. Naturally, it is also possible to design the projection such that the cover can only be opened with the knife in the position shown in FIG. 8. Then, the risk of the knife accidentally slipping back is prevented.

In FIG. 10, in top plan view, a further alternative embodiment of an apparatus 1 according to the invention is shown, wherein, however, within the housing 2, four rolls of tape 3A-3D are included. With this apparatus 1, four types of tape 7, for instance in four different colours, can be dispensed, for instance red R, green G, blue B and white W. Within the housing 2, four dispensing apparatuses 4 are disposed, such as, for instance, described with reference to FIGS. 1-7, while for each roll 3A-3D of tape 7, cutting means with operating means 32A-32D are provided. Furthermore, operable blocking means 66A-66D are provided with which the operating handles 5 for the different dispensing apparatuses 4 can be blocked or can be released at will. For instance, with the button 66A (R), the first driving wheel 18 of the respective dispensing apparatus 4 can be released while, simultaneously, the first driving wheels 18 of the further three dispensing apparatuses 4 are blocked, so that only red tape 7 will be dispensed. By pushing the second button 66B (G), then, green tape 7 can be dispensed, by pushing the button 66C (B), blue tape and by pushing the fourth button 66D (W) white tape 7 can be dispensed. The blocking means 66 can be designed in a simple manner such, that only one type of tape 7 can be dispensed at one time or such that different colours of tape 7 can be dispensed at one time. Such a dispensing apparatus is for instance particularly suitable for dispensing installation tape used by, for instance, electrical fitters, technicians or the like. Naturally, also different numbers of rolls 3 can be provided with associated dispensing apparatuses and cutting means.

When in an apparatus 1 according to FIG. 10 the cutting means virtually abut each other, such an apparatus can also be used in a simple manner for dispensing relatively wide tape. The fact is that then, for instance, a roll of tape 3 can be inserted, having the width of two, three or four rolls as shown in FIG. 10, while movements of the associated, adjacent dispensing apparatuses can be coupled, as can those of the cutting means Thus, an even broader applicability of such an apparatus is obtained.

The invention is not limited in any manner to the exemplary embodiments represented in the description and the drawings. Many variations thereon are possible within the framework of the invention as outlined in the claims.

For instance, all sorts of other operating means can be used for rotating the rolls of tape and transporting tape in the direction of the dispense opening 6, while, emphatically, combinations of housings and dispensing apparatuses as shown in the different Figures can be combined and housings can also be in part, in particular at the location of the rolls 3. In the exemplary embodiments shown, each time, the axles of the driven wheels 18 and the rotation axis of the roll 3 are parallel to each other. However, it will be clear that also, in a simple manner, these axes can be arranged at an angle relative to each other, for instance by guiding the tape therebetween along a further guiding mechanism, for instance a guiding roller disposed at an angle. What can be thus achieved is that with a dispensing apparatus according to, for instance, FIG. 1, tape can be dispensed in a plane parallel to the drawing while the roll 3 remains in the position described. Naturally, to that end, the dispensing apparatus 4 is rotated through 90°. Further, within a housing, rolls 3 can be arranged one over the other instead of next to each other, so that various rolls can be received in a narrower housing. By the substantially linear movement of the cutting means, the tape being inadvertently guided back into the housing is prevented in a simple manner. Moreover, a knife can thus be moved relatively closely along a dispense opening, which dispense opening can have a virtually flat design. As the cutting means are always confined virtually completely within the housing, injury or damage of the surroundings is prevented.

In the exemplary embodiments shown in the Figures, tape is moved in and through the dispense opening by movement of the handle. However, it will be clear that such an apparatus can be designed such that the tape can be manually pulled through the dispense opening.

These and many comparable variations are understood to fall within the framework of the invention as outlined by the claims.

1. An apparatus for dispensing adhesive tape, provided with a housing and receiving means for receiving a supply roll of adhesive tape and guiding means for, during use, feeding to and through the dispense opening a leading end of adhesive tape unwound from the supply roll, wherein cutting means are provided for cutting adhesive tape from the supply roll brought outside the dispense opening, wherein operating means are provided for moving the cutting means between a first position largely retracted in the housing and a second, cutting position, wherein the cutting means can be brought into contact with adhesive tape fed into and/or through the dispense opening

2. An apparatus according to claim 1, wherein the cutting means are biased in the first position.

3. An apparatus according to claim 1 or 2, wherein, in both the first and the second position, the cutting means extend virtually completely within the housing.

4. An apparatus according to any one of the preceding claims, wherein the housing is provided with locking means for at least partly confining a supply roll within the housing, wherein blocking means are provided for the cutting means and/or the operating means therefor, which blocking means are designed such, that the locking means can only be opened and/or taken away when the cutting means have been brought into the first position.

5. An apparatus according to claim 4, wherein the housing comprises a flap, wherein the blocking means can be operated by the flap.

6. An apparatus according to claim 4 or 5, wherein, by operating the blocking means, in particular by opening the flap, the operating means for the cutting means are blocked.

7. An apparatus according to claim 5, wherein the blocking means are designed for preventing the flap from opening before the cutting means have been brought into the first position.

8. An apparatus according to any one of the preceding claims, wherein the guiding means comprise at least one driven roller with which, during use, adhesive tape can be moved in the direction of and through the dispense opening.

9. An apparatus according to claim 8, wherein a driving mechanism is provided for manually driving said at least one driven roller.

10. An apparatus according to any one of the preceding claims, wherein the apparatus is arranged for dispensing tape for medical application, in particular on or adjacent the skin.

11. An apparatus according to claim 10, wherein the apparatus is autoclavable or differently sterilizable.

12. An apparatus according to any one of the preceding claims, wherein the housing comprises a handle and a body, wherein the receiving means for the supply roll are provided in the handle and the operating means substantially in the body.

13. An apparatus according to any one of the preceding claims, wherein the apparatus is substantially manufactured from metal parts.

14. An apparatus according to any one of claims 1-9, wherein the apparatus is arranged for dispensing adhesive tape for closing boxes and the like, wherein the housing comprises a handle and a body, wherein the receiving means for the supply roll are substantially received in the body, together with the guiding means.

15. An apparatus according to any one of the preceding claims, wherein the cutting means comprise a knife, received in a substantially straight guide, which is substantially linearly movable between the first and the second position.

16. An apparatus according to any one of the preceding claims, wherein the receiving means for the supply roll are fastened to a base plate which is movable relative to the housing, wherein a pressure roller is connected to the base plate for pressing on adhesive tape extending along said pressure roller, the pressure roller being arranged for pushing the adhesive tape through the dispense opening.

17. An apparatus according to any one of the preceding claims and a supply roll of adhesive tape, wherein the receiving means comprise first receiving elements and the supply roll comprises a core with second receiving elements, wherein the first and second receiving elements are tailored to each other such that the supply roll can only be inserted with the core onto the receiving elements in one position.

18. An apparatus according to claim 17, wherein the receiving means comprise a stub onto which the core of the supply roll can be slipped, wherein the housing comprises a cover which can be closed over the supply roll, which cover, in closed position, is located at a relatively small distance from the core.

19. An apparatus according to any one of the preceding claims, wherein at least two receiving positions for supply rolls of tape are provided, wherein means are provided for, during use, dispensing and cutting off tape from at least one of the supply rolls, at will.
